(19) United States
(12) Patent Application Publication
(10) Pub. No.: US 2015/0025993 A1
(43) Pub. Date: Jan. 22, 2015

(54) Electronic On-line Motor Vehicle Management and Auction System

(71) Applicants: Mauricio Kiglies, Addison, IL (US); Adrian Kiglies, Hoffman Estates, IL (US)

(72) Inventors: Mauricio Kiglies, Addison, IL (US); Adrian Kiglies, Hoffman Estates, IL (US)

(21) Appl. No.: 14/298,430

(22) Filed: Jun. 6, 2014

Related U.S. Application Data
(60) Provisional application No. 61/832,287, filed on Jun. 7, 2013.

(51) Int. Cl. G06Q 30/08; G06Q 30/02

(52) U.S. Cl. CPC G06Q 30/08; G06Q 30/0278
USPC 705/26.3

(57) ABSTRACT

The present system provides standardized method and procedures to inspect, sell, auction and purchase used vehicles. The system provides certified technicians that go to the car dealers' location to obtain the information related with the vehicles to be sold. The technicians record the condition of the vehicle while inspecting it, and evaluate the vehicle's condition. The information is presented to potential buyers to solicit offers and bids on the vehicles to be auctioned. An online auction session will be conducted to invite bids from the registered users. A final winner will be determined by the system.

This application claims priority to provisional patent application Ser. No. 61/832,287 filed Jun. 7, 2013 to the extent allowed by law.

### BACKGROUND OF THE INVENTION

1. Field of the Invention

The present invention relates to vehicle auctions and specifically to vehicle auctions managed and conducted by the use of computer systems and networks. The current invention is directed to licensed auto dealers and integrating the onsite inspection of vehicles for sale by the dealer, posting information online, providing different types of auctions and post-sale services, all to assist the auto dealers selling their trade-ins and aged inventory.

2. Background of the Invention

A car dealership or local vehicle distribution sells new or used cars at the retail level. The dealership employs automobile salespersons to do the selling based on a dealership contract with an automaker or its sales subsidiary. Auto auctions are a method of selling new and used vehicles based on an auction system. Auto auctions used to be a protected source for used car dealers in the United States and therefore are not often used by most people. The general public is not allowed in dealer only auctions, however some public auctions are open to the general public.

In the United States, auto auctions are relatively unknown to the public at large, but play a major role as a wholesale market for pre-owned vehicles. Most auto auctions are closed auctions for dealers only. As a special form of vehicle auction, a car dealer auction is restricted from the general public and only licensed dealers can participate. Millions of vehicles are sold at such dealer auto auctions every year. Traditional vehicle auctions require a seller to deliver the car to the auction, and have a run or lane number issued to the vehicle for it to be auctioned. The dealers might need to send a representative or pay the auctions to represent vehicles on auction day to represent the cars subject to the auction. If the car sells, the dealers are charged a selling fee and are susceptible to arbitration and can expect to be paid once the dealer surrenders a good title.

Prices of vehicles sold at dealer auctions tend to be lower than those advertised on any dealer's lot for a number of reasons. Most vehicles sold at auto auctions are trade-ins, off-lease returns, replaced rental fleets, company cars, repossessed vehicles, aged inventory, as well as salvaged, damaged and tow vehicles. The overall vehicle conditions of these used vehicles vary greatly. From little or no damage to damage including total loss, insurance claims, stained or otherwise used upholstery, scratched bumpers, dings on the doors, chipped hood, dented quarter panels, etc. The automobiles may also have useful extras and sometimes even after market modifications.

Regardless of the source and condition of the vehicles, the main purpose of sending the vehicles to an auction is to sell them quickly and hassle-free. The sellers put reserve prices on their stock to prevent the cars selling for unreasonably low prices. The reserve price is not disclosed publicly and a “winning” auction bid is only considered a sale if the reserve price is met. If the car does not sell, the dealer is usually charged a “buy back fee” and has to pay for the transportation of the car back to the dealer. The dealer has lost the opportunity to retail the vehicle at auction because the vehicle is removed from the dealer's lot.

Mechanics and guests are usually allowed a limited amount of time to inspect the vehicle prior to the sales to see the cars until after the sale is completed. The law does require the dealers to disclose significant mechanical problems, which may void the manufacturer's warranty and classify the vehicle as junk, salvage, lemon/consumer buy-back, etc. Some auction locations inspect and prepare the cars for sale at a premium if the listing dealer so chooses. More extensive reconditioning is also available. Many auctions offer post-sale inspections for qualifying vehicles which can determine mechanical or frame damage issues which allow the buying dealer a window of opportunity to back out of the purchase.

Online auto auctions are growing in popularity in order to cut the expense of purchasing vehicles in the auto auctions and to expedite the entire process. One of the most popular online auctions to purchase cars from is eBay. On eBay Motors, any user can register for an account and put their vehicle(s) up for auction. However, the risk associated with the online auction process is significantly greater, and many buyers prefer to look for local car sellers within a certain geographic radius so that the buyers can conduct a manual inspection of the vehicle prior to purchase.

One attempt at implementing an online auto vehicle auction system is described in U.S. Pat. No. 7,908,180 (“Goclowski”). The system disclosed in Goclowski is an online automobile auction, which allows the consumer to participate by using their home or portable computers and by accessing the system via an Internet connection. Before the designated time for an auction, the consumer may access the database of available automobiles. The disclosed system displays visual depictions of the vehicles, and prior to the auction, a plurality of bidders input their minimum starting bid, the maximum bid and the incrementing value. The system disclosed in Goclowski does not exclude the seller from inputting the information regarding the vehicle they would like to put up for sale or auction. It also does not disclose a detailed description including images of the vehicle for auction or sale or an evaluation of the vehicle based on the condition of the car.

### SUMMARY OF THE INVENTION

The present invention provides for a standardized system and method for selling and purchasing used vehicles through the Internet. The system provides certified technicians that go to the car dealers' location directly to obtain the information related with the vehicles to be sold. The information includes the VIN number of the car, model, type, condition, multimedia files of the car, and the evaluation scores given by the mechanics based on their on-site inspection of the condition of the vehicles. The information and evaluation messages are directly loaded into the sales database system from the mechanics' mobile devices. The system will generate a report for the vehicle to be sold, along with all the general condition information of the car collected by the mechanics and the financial information collected by the sales personnel.

After the condition reports are posted on the system's website and before the live auction starts, the potential buyers can access the information online and purchase the cars they selected, with the seller provided financial options, for example car sold with/without reserve, buy now price or make offers. The cars not sold at the “Make an offer,” “buy it now,” or pre-auction bidding sessions will be listed for sale on the auction and open for live bids. All live auctions will start at zero dollars, the pre-auction bids will then be published at the auction to solicit more bids during the auction process. Whenever there is a valid new bid made by a bidder, the system will reset the auction timer to a random time period that decreases to determine the auction time to accept bids from the bidders.

### BRIEF DESCRIPTION OF THE DRAWINGS

The features of the present invention which are believed to be novel are set forth with particularity in the appended claims. The invention may best be understood from the following detailed description of currently preferred embodiments thereof taken in conjunction with the accompanying drawings wherein like numerals refer to like parts, and in which:

FIG. 1 is an overview of the structural components of the onsite information collection program and online management and auction system.

FIGS. 2A and 2B are flow diagrams of the process to obtain and analyze the VIN of the inspected vehicle.

FIGS. 3A and 3B are flow diagrams of the process to obtain the basic data in the mobile database.

FIG. 4 is a flow diagram illustrating the recording of optional equipment information.

FIG. 5 is a flow diagram of the process of the detailed condition inspection and reporting process.

FIG. 6 is a screen shot of the condition report editing page of the present program.

FIG. 7 is a flow diagram illustrating the process of obtaining and recording the wheel and tire information of the inspected vehicle.

FIG. 8 is a flow diagram showing the process of obtaining, editing, and saving multimedia file during inspection.

FIG. 8A is a screen shot of the multimedia file tagging page during the multimedia editing process.

FIGS. 9A, 9B, and 9C are flow diagrams of the process of a buyer offers a maximum pre-bid and the system processing the maximum pre-bid.

FIGS. 9D, 9E, and 9F are flow diagrams of the process of a buyer offers a regular pre-bid and the system processing the regular pre-bid.

FIGS. 10A and 10B are flow diagrams illustrating a buyer sends an offer to seller before the online auction starts.

FIGS. 11A and 11B are flow diagrams illustrating the processing of the offer sent by the buyer in FIGS. 10A and 10B and the negotiation process of the offer.

FIG. 12 is a flow diagram illustrating the administrative control of the auction process.

FIG. 13 is a flow diagram of the general auction process.

FIG. 14 is a flow diagram showing the process of entering an online live bid by the bidding buyer.

FIG. 15 is a flow diagram of the process of divulging the pre-bids collected through the pre-bidding and the processing of the pre-bids and online bids.

FIG. 16 is a flow diagram of the determination process of the winner of the auction of the vehicle.

### DETAILED DESCRIPTION OF THE ILLUSTRATED EMBODIMENTS

The present system features a standardized valuation and procedure to report and manage the condition and the value of a vehicle for purchase from a dealer. During prior art vehicle auction processes, the information regarding the vehicle to be auctioned is gathered and reported by the selling dealer to an auction representative. The selling dealer provides his or her own opinion on the condition of the vehicle and the estimate sales value based on previous dealings with similar vehicles.

In order to collect more accurate and complete information for the buyers to make the purchasing decision, the present invention dispatches certified professionals to inspect and prepare a report regarding the relevant information of the vehicles to be auctioned. The professionals conducting the inspection are typically certified by the non-profit National Institute for Automotive Service Excellence (ASE). The professionals are trained with the technology and diagnostic tools in the automotive profession. These certified technicians represent the system, not the selling dealers, and provide reliable information to report to the system's database, which data is ultimately provided to the prospective buyers.

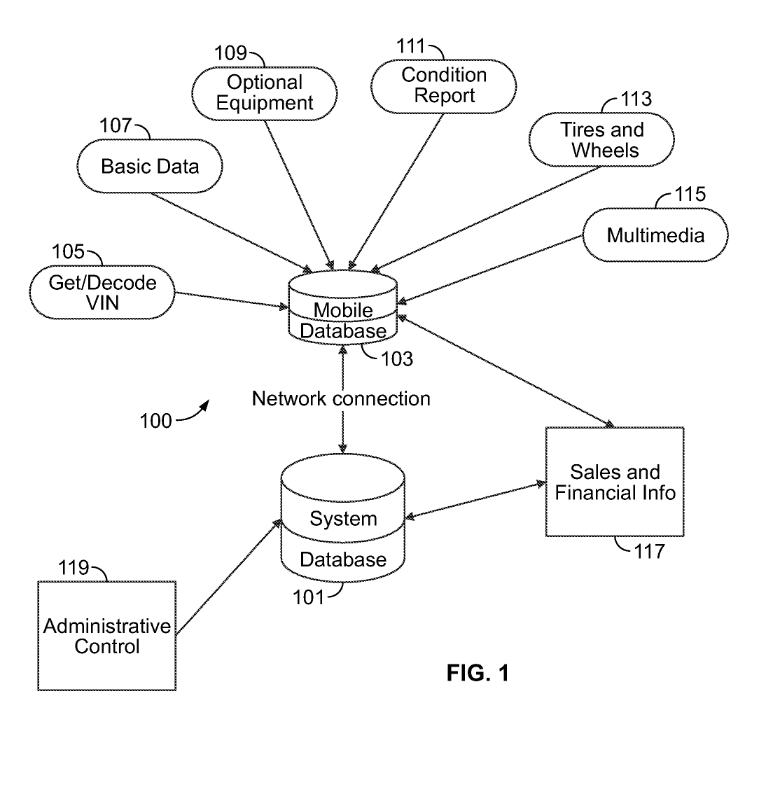

FIG. 1 provides an overview of the onsite information collection system 100 and communication of the collected information with the system database 101. The ASE certified technicians are sent to the site of the automobiles and the collected information is stored in the mobile device they carried with them to the inspection. The inspection procedures and requested information are preloaded into the technicians' mobile devices. Once the technician inputs information in the mobile device following the preloaded procedures, the information is stored in the mobile device database 103 and directly uploaded to the corresponding files in the system's database 101.

The technicians will record information including the VIN information 105, basic data of the vehicle 107, optional equipment 109, a condition report 111, information relating to the condition of the tires and wheels 113 and multimedia files 115. Each of these information components are obtained through processes detailed hereinafter.

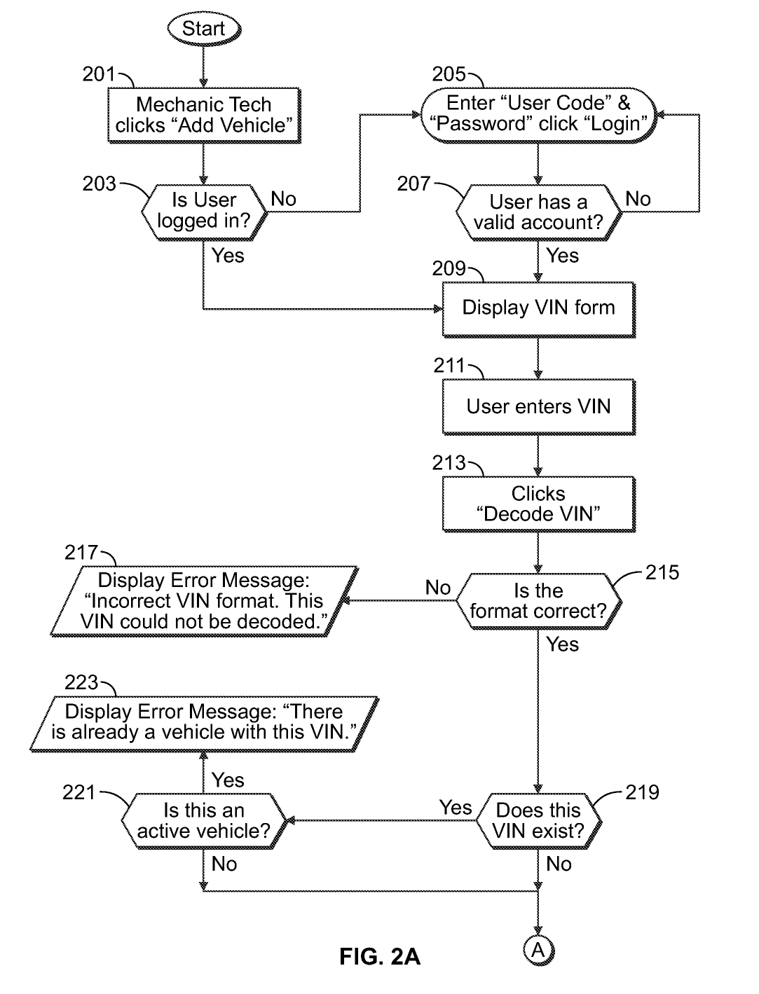

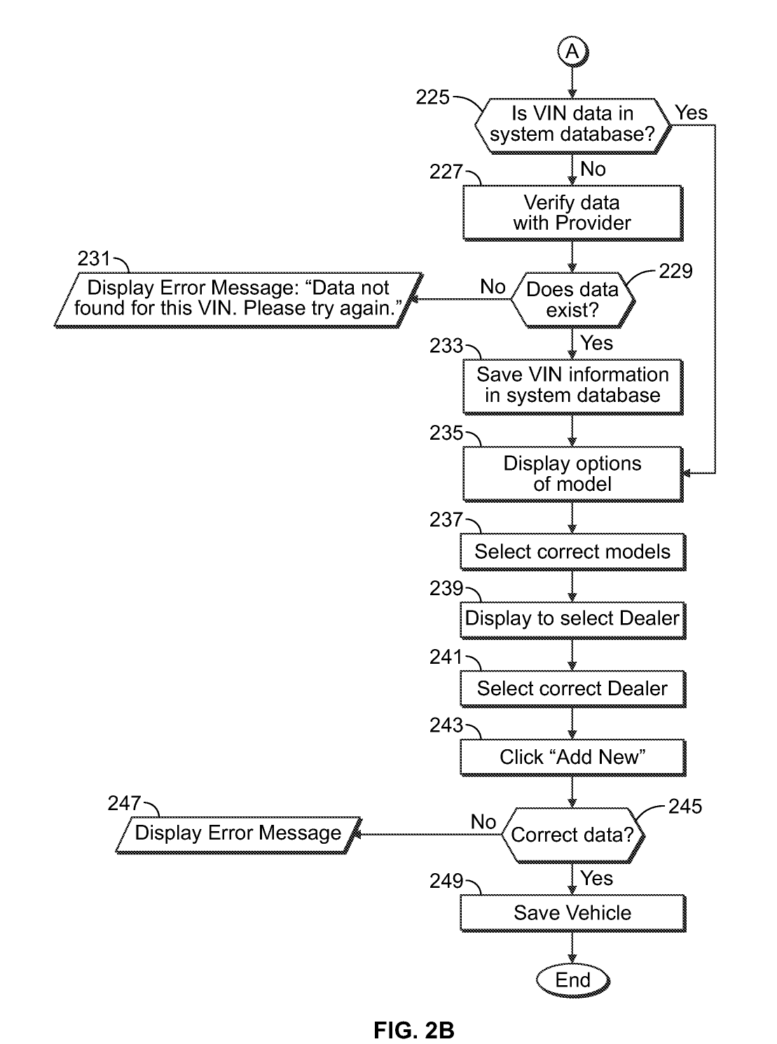

Obtaining and decoding the vehicle identification number (VIN) 105 is an important step to identify individual motor vehicles and understand their histories. Referring to FIGS. 2A and 2B, the flow diagram illustrates the process to obtain and analyze the VIN in the present system. The certified technician obtains access to the preloaded program on the mobile device he or she took to the onsite inspection. The technician sends a command to the mobile program to add a vehicle by clicking on “Add Vehicle” at step 201, shown in FIG. 2A. The program will verify the user's identity at step 203, because only a logged in user has the authority to add to and/or edit a vehicle's information. The certified technicians associated with the system in the present invention have their individual accounts and passwords to login to the mobile program. If the technician is not logged in, the technician is required to input a user id and password at step 205 if he or she is not identified by the program yet. The program will allow the technician to reenter an id and/or password at step 207 if the account is not valid.

The technician will be directed to enter the VIN of the inspected vehicle at step 209. The VIN information can be entered into a VIN box or form in one embodiment of the invention. After the technician enters the VIN at step 211 and initiates the decoding VIN process by clicking “Decode Vin” at step 213, the program determines the format of the VIN after receives it. The mobile program will transmit the VIN to the system database 101 to analyze and decode the VIN through a network connection. Steps 215 and 217 determine whether the entered VIN is in the correct format. Once the format of the VIN is confirmed, the program continues to determine whether the vehicle is previously recorded in the vehicle management system at step 219. If the vehicle already exists in the management system's database 101, and the system 101 determines the vehicle corresponding with the entered VIN is an active vehicle recorded in the system, the program will deliver an error message to the technician at step 223. If the VIN does not exist in the management system's database 101, or the vehicle is not an active vehicle in the system, the program will continue to determine whether the main management system has the vehicle's information. At step 225, shown in FIG. 2B, the program compares the entered VIN with the VINs stored in the system database 101. If the vehicle's information is not yet recorded in the main system database 101, the program will request the technician to verify the vehicle's data with the manufacturer's data according to the VIN at step 227. The verified data includes the year, make, model, standard and optional equipment the manufacturer offers for the inspected vehicle. Steps 229, 231 and 233 respond to the verification of the VIN information. An error message will be sent to the technician if the data is not found at step 231, and the information obtained for the entered VIN will be saved to the main system database 101 at step 233.

The data for the inspected vehicle will be associated with the appropriate vehicle model and selling dealer. Steps 235 and 237 provide various car models for the technician to select and steps 239 and 241 are provided to select the seller dealer. The data of the vehicle, model and selling dealer will be stored to the added new car's file at steps 243, 245, 247 and 249.

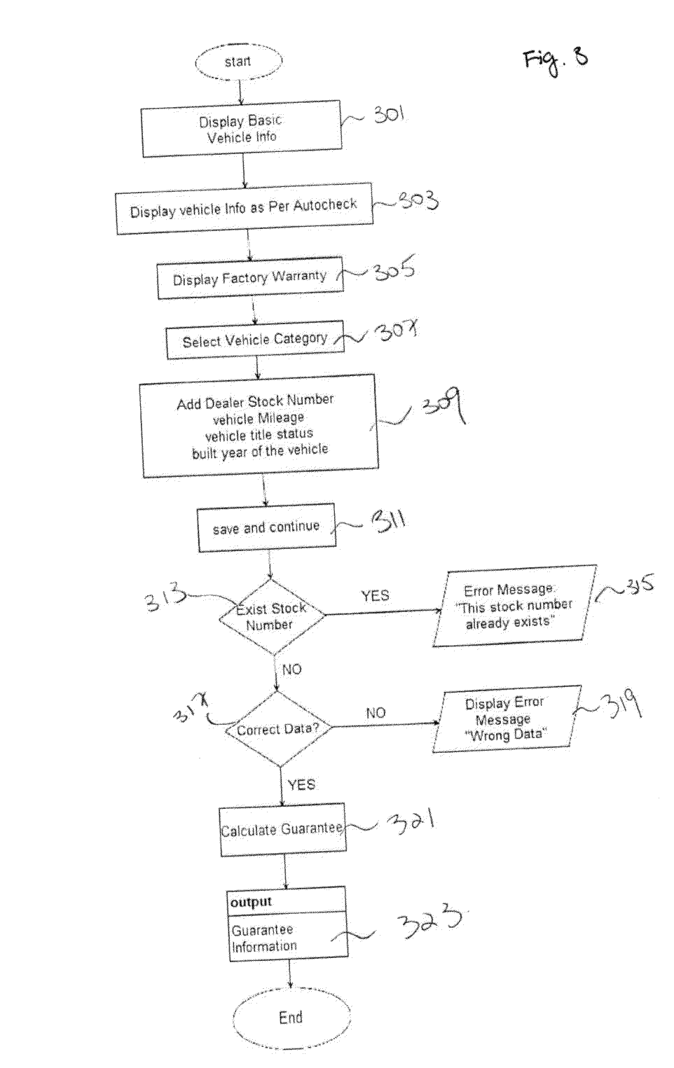

FIGS. 3A and 3B illustrate the detailed process to obtain the basic data 107 in the mobile database 103 shown in FIG. 1. After the VIN information is collected and stored in the system as described in FIGS. 2A and 2B, the technician can select the basic information tab in the mobile program and be directed to the page to fill out the basic information of the inspected vehicle. The VIN information collected from get/decode VIN 105 shown in FIG. 1 is associated with the basic vehicle information and the recorded history of the inspected vehicle. Step 301, shown in FIG. 3A, displays the basic information page for the technician to follow the process to input the information. The vehicle information regarding the full history of the vehicle as per autocheck will also be displayed at step 303. This helps the technician to better understand the history of the inspected vehicle. The program will display the factory warranty of the vehicle at step 305. At step 307, the technician will manually select the vehicle category. The technician reviews other basic information for accuracy and inputs the basic information into the system at step 309. The information includes, but is not limited to: the dealer's stock number, mileage on the vehicle, whether the vehicle has title and what the status of the title is, and the year the vehicle was built. The inputted information is saved in the mobile database 103 at step 311. The saved information is uploaded to the system database 101 directly from the mobile database 103 when the technician's mobile device is connected via a computer network, such as the Internet.

When the system receives the dealer stock number from the technician through network communication, the system will conduct a search to determine whether the stock number already exists at step 313, shown in FIG. 3B. It is possible that different selling dealers use the same stock number for different cars, and duplicate stock numbers may cause confusion. If the stock number already exists in the system database 103, an error message will be sent to the technician at step 315. Steps 317 and 319 confirm that the inputted data is correct and issue an error message if the data is not correct.

After all the relevant basic information is collected and inputted into the system database 103, the system will calculate the year and mileage on the vehicle at step 321. The calculated year and mileage information will be output by the system and displayed in the inspected vehicle's report at step 323.

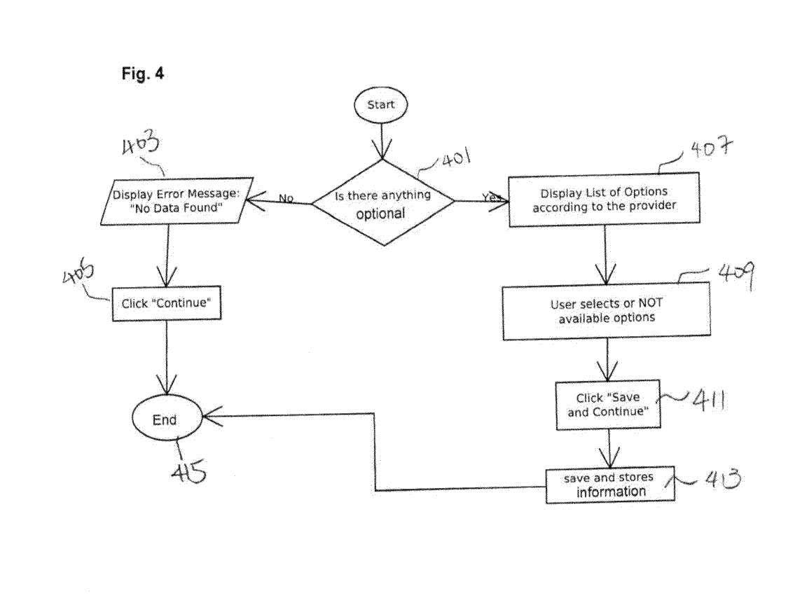

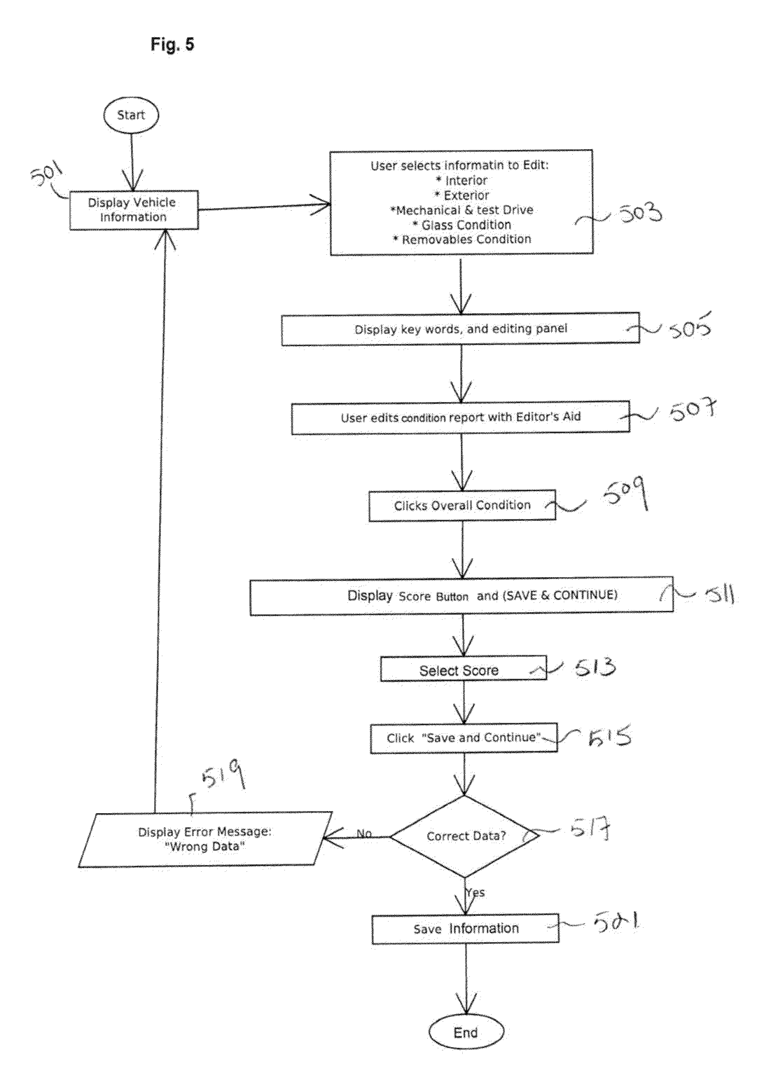

Vehicles are equipped with standard equipment that come with the vehicles of the same type and optional equipment from the manufacturer. Manufacturer optional equipment added to a used vehicle may affect the value of the vehicle. Before the technician starts to inspect on the optional equipment, the system will load all the standard equipment for the inspected vehicle's type on the technician's mobile device. The technician inspects the optional equipment 109 shown in FIG. 1 and records the information in the mobile database 103. The optional equipment data is recorded in the system as illustrated in FIG. 4. The technician responds to the inquiry at step 401 as to whether there is any optional equipment on the inspected vehicle. If the answer is no, the mobile program will display an error message at step 403 and the program continues to the end of the optional equipment recording at steps 405 and 415. If the technician answers that there is additional equipment to record at step 401, the mobile program will display a list of preloaded optional equipment at step 407. In one embodiment, the preloaded list of optional equipment can be obtained from the manufacturer of the vehicle according to the VIN. At step 409, the technician selects the equipment from the list or indicates that the optional equipment is not available on the list. The information will then be saved and the mobile program will end the recording of optional equipment at steps 413 and 415. If there is no optional equipment available equipment for the vehicle there will not be an optional equipment tab in the condition report it generates on the public site. The mobile program then continues to direct the inspecting technician to the next process to report the condition of the vehicle.

Condition report 111 in FIG. 1 is to record the detailed appearance and overall performance of the inspected vehicle. FIG. 5 further illustrates the inspection and reporting process. The system displays the categories of inquired information at step 501 when the technician enters the user interface for the condition report. A list of information is available for the technician to select, edit, and add in descriptions. Step 503 shows an example of listed information including: interior, exterior, mechanical and test drive, glass condition and removable condition. The technician is directed to input information related with each listed category directly by clicking on the keywords as well as by typing the information as the technician sees fit. When the technician clicks on a specific category to edit, the mobile program will display a list of related key words and an editing panel to facilitate editing the information quickly and accurately.

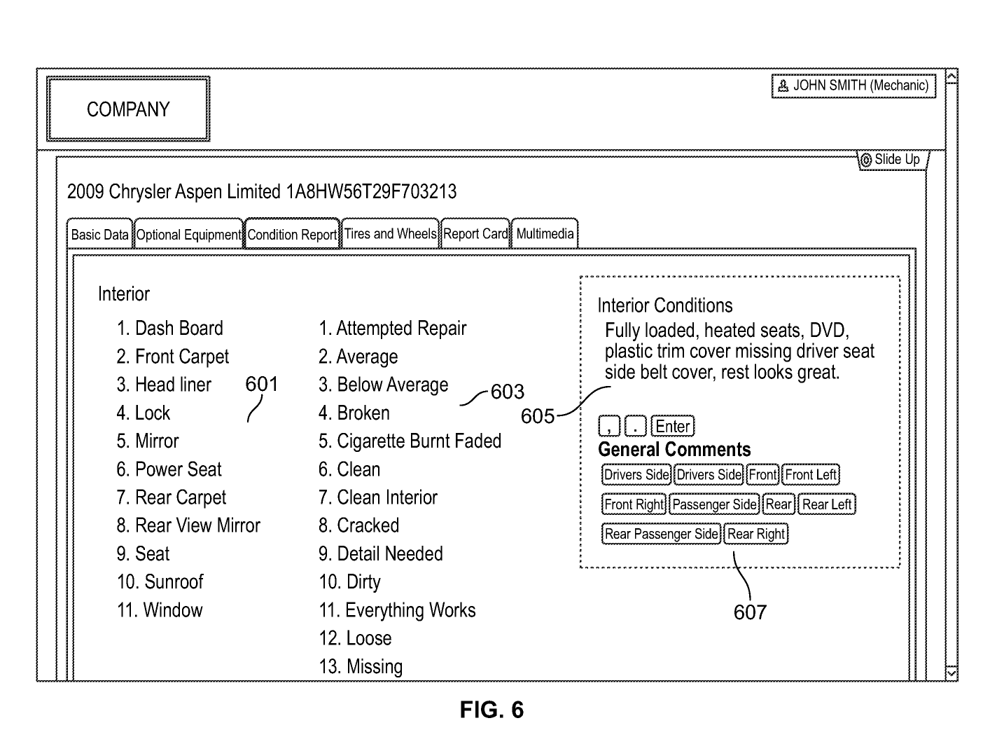

FIG. 6 illustrates an embodiment of the technician editing page used in the condition reporting process of the present invention. Depending on different areas of the vehicle, the editing page contains a group of location and parts indicators 601, a group of condition indicators 603, a general comments key words list 607, and a text editing box 605. For example, when the technician is editing the condition of the interior of the vehicle, the location and parts indicators 601 give the technician the option to choose from dash board, front carpet, headliner, lock, mirror, power seat, rear carpet, rear view mirror, seat, and sun roof. When the technician clicks on one of the indicators, the selected word will be added to the text editing box 605. Condition indicators for the interior parts include: attempt repair, average, below average, broken, cigarette burnt, faded, clean, cracked, detail needed, dirty, everything works, etc. The selected condition indicators will also be added to the text editing box 605.

Multiple words can be combined from each group and used to describe the detailed condition of the inspected vehicle. Other than selecting words from the provided lists, the technician can also type in his or her own descriptions or statements in the text editing box 605. Providing the preloaded list for the technician to select and edit the condition saves time in editing the condition report, and ensures the description submitted by the technician is in a standardized format in describing the location and parts of the vehicle and the corresponding conditions.

Referring back to FIG. 5, after the technician edits the condition report 503, 505, 507, the technician will be directed to the overall condition rating function on the mobile program. The technician clicks the overall condition button at step 509 to command the program to display score buttons for the technician to select at 511. In one embodiment of the present invention, the score buttons are numbered from 1-10 to indicate the overall quality and condition of the inspected vehicle. A sample chart of the grading criteria is listed in the table below:

| Score | Status | Detailed Status |
|---|---|---|
| 1 | VERY BAD | Does not run, major mechanical and aesthetic |
| | | flaws, possibly only dismantled parts of a car. |
| 2 | BAD | Major mechanical and aesthetic flaws. |
| 3 | WAY BELOW | Major aesthetic or mechanical flaws. |
| | AVERAGE | |
| 4 | BELOW | Drives OK, needs moderate mechanical or |
| | AVERAGE | aesthetic work. |
| 5 | AVERAGE | Drives good, shows wear and might need minor |
| | | mechanical or aesthetic work. |
| 6 | GOOD | Good driver with minor mechanical and |
| | | aesthetic flaws. |
| 7 | VERY GOOD | Minor mechanical and aesthetic flaws. |
| 8 | FINE | Very minimal wear, mechanical or |
| | | aesthetic flaws. |
| 9 | EXCELLENT | Near flawless and free of aesthetic or |
| | | mechanical issues. |
| 10 | PERFECT | This vehicle is new or if used, flawless |
| | | free of any aesthetic or mechanical flaws. |

After the program receives the reported information and the technician's grading information 513, 515, the data will be confirmed at step 517. If the data is inaccurate or includes mistakes, the program will display an error message at step 519 and the program will restart the condition report process from step 501. When the program confirms the input data is correct, it will save the information collected at step 521 and continues to the next page.

The skill and professionalism of the inspecting technician is highly important in the evaluating and grading process illustrated in FIG. 5. The technicians assign the rating scores to the inspected vehicles solely based on their discretion and observation. The ASE certified mechanics designated by the present system constitute a reliable source for the rating scores.

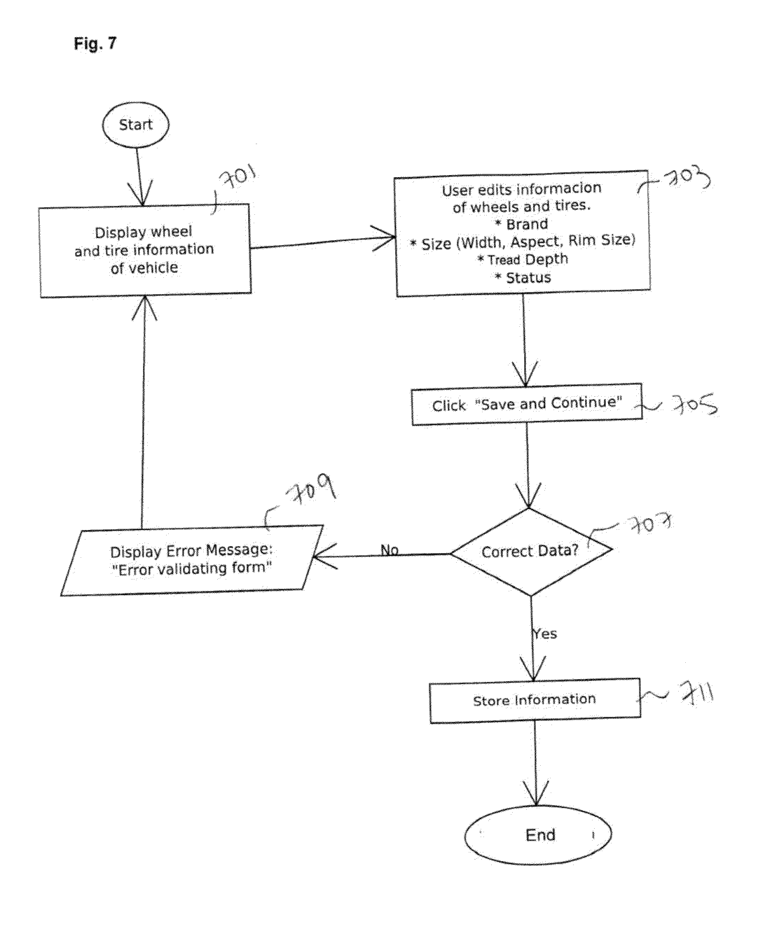

Turning to FIG. 7, this figure illustrates the gathering of wheel and tire information of the inspected vehicle. The mobile program directs the technician to inspect the wheels and tires at step 701. Step 703 lists categories of information the technician should collect, including: brand, tread depth of each tire, status of wheels and tires, and the width, aspect, and rim size. The recorded information is saved at step 705 and confirmed at 707 and 709.

The multimedia function 115 in FIG. 1 allows the technician to insert explanatory tags into the multimedia files. The multimedia files are directly uploaded from the mobile database 103 to be generated in the vehicle's report in the system database 101.

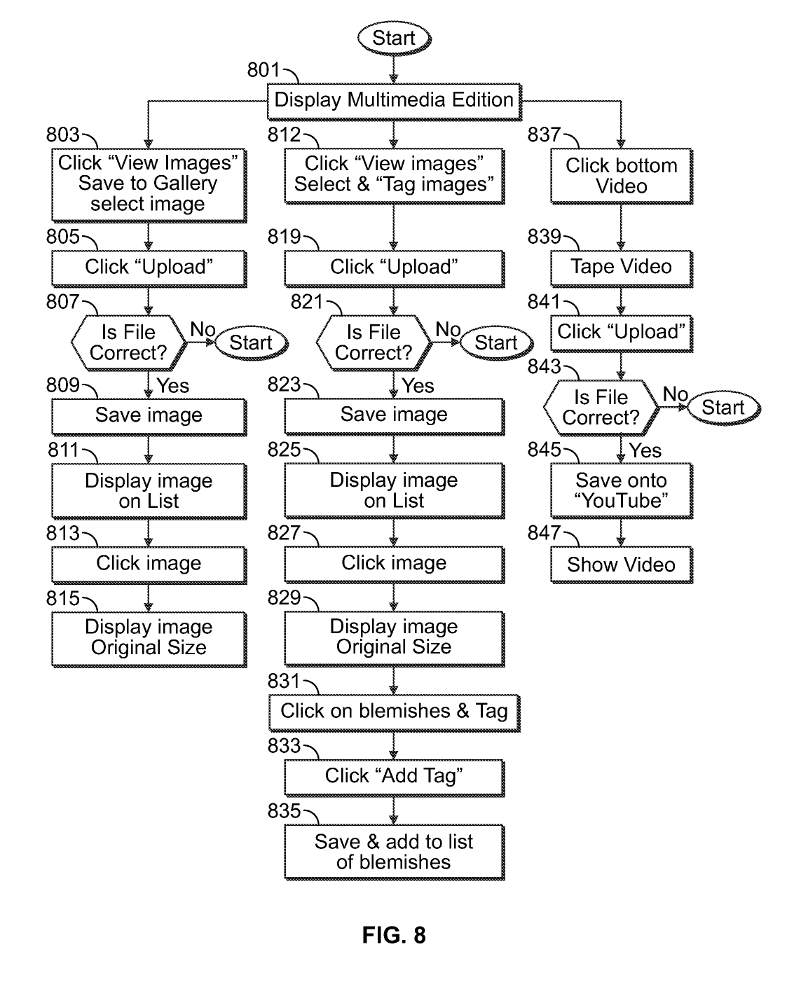

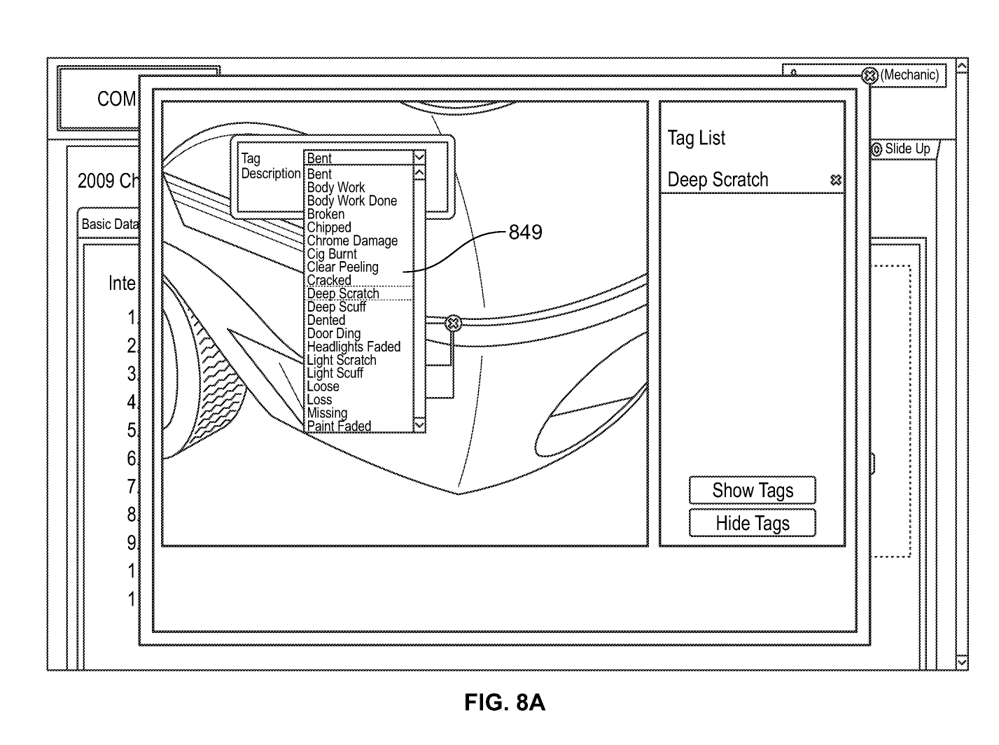

FIG. 8 illustrates the collecting and processing of multimedia files in the present invention. The inspecting technicians take pictures of the vehicle and note or tag information at the corresponding areas in the pictures. The pictures are saved in mobile device database 103 and directly uploaded to the system database 101. The technicians can also take video files of the inspected vehicle and upload the files directly to Internet services such as YouTube®.

The program directs the inspection technician to the multimedia edition page at step 801. Steps 803-805 allow the technician to select the images to upload to the system. The uploaded image can either be from the pictures gallery on the technician's mobile device, or taken by the technician at the time the picture is uploaded. The system confirms the file at step 807 and redirects the technician back to start if the file is incorrect. The image files are saved at step 809. They can be viewed from the system database 101 or from the mobile program on the technician's mobile device.

Steps 817-835 show the process of tagging information at the corresponding areas on the uploaded images. Steps 819-829 are similar to the processes described in steps 805-815. The technician can add a tag to blemished areas on the picture. FIG. 8A shows an image of a vehicle uploaded to the system. Highlighted box 849 is selected by the technician at step 831 to tag the scratch on the vehicle body. The technician then adds a statement to describe the tagged blemishes at step 833, and the statement is saved 835 together with the tag and image in the system.

Step 837 directs the technician to take a video of the inspected vehicle. The technician can tape record at least one video of the vehicle by the mobile device at step 839. The video is then uploaded 841, confirmed 843 and saved to the mobile database 103 and/or directly onto internet services such as Youtube® 845. The video can be reviewed by the technician and authorized users through the present system.

All the information collected and processed in the inspection procedures is transmitted to the system database 101 in FIG. 1 and compiled to constitute an important part of the vehicle report. Selected information in the vehicle report is presented as a file to the potential bidders participating in the auction to help the bidders with their purchasing decisions. Besides the vehicle's physical information, the vehicle report also contains the sales and financial information of the vehicle 117. The sales and financial information includes the “buy now” price for the vehicle, the reserved price, and the selling dealer's preference on how the vehicle is to be auctioned.

After the vehicle information is generated and compiled into a report, yet before the actual live auction of the vehicle starts, the potential buyers can review the vehicle information online through the system's website. As a bidder reviews the vehicle report on the system's website, the information collected by ASE certified technicians will be displayed at the report page. The bidder is also able to identify the specific technician who performed the inspection on the vehicle, including the technician's background and credential information. The system allows potential buyers to submit offers until a predetermined time before the live auction starts. A vehicle can be sold before the actual auction takes place through offer exchanges between the buyer and the selling dealer.

There are at least three ways that a vehicle can be removed from the live auction list. One of them is the selling dealer withdrawing the vehicle from the auction. This can happen when the selling dealer sells the vehicle via other methods before the vehicle is successfully sold via the present electronic on-line motor vehicle management and auction system.

Another way that a vehicle can be sold before the live auction is when the selling dealer offers a “buy now” price and the price is accepted by one of the potential buyers. Once the “buy now” price is accepted by a buyer, the accepted offer stops the pre-auction offer and counter offer processes. The vehicle will be removed from the auction list and its status will be changed to “sold.”

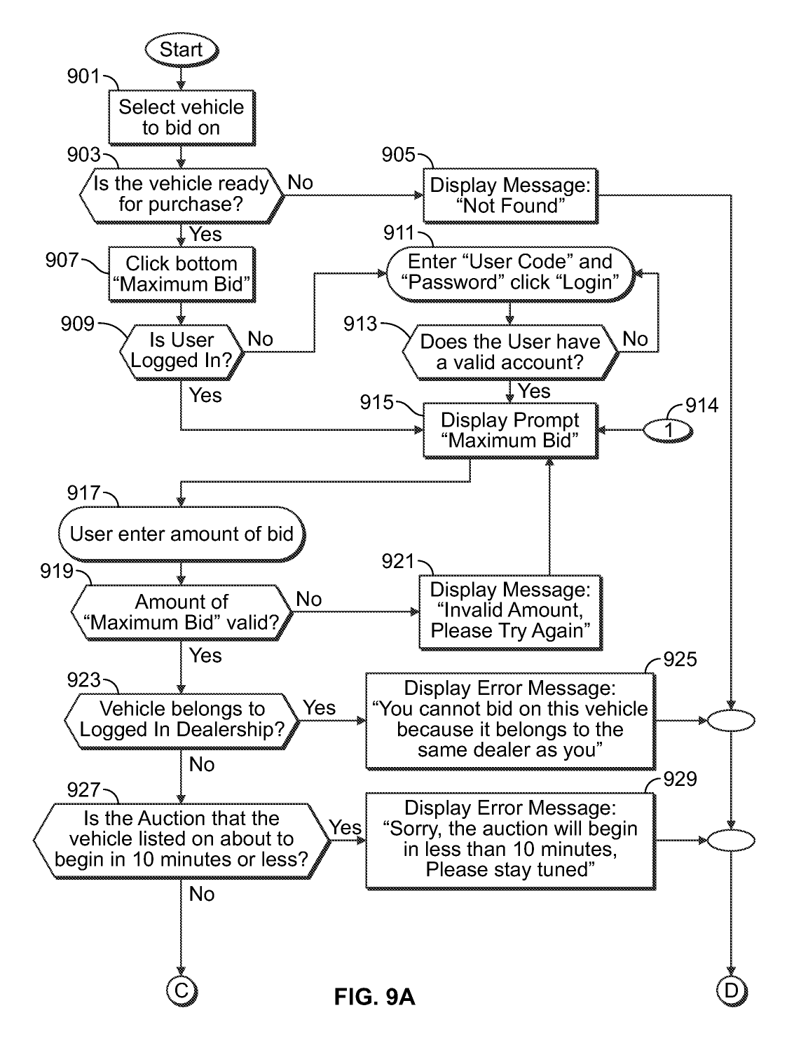

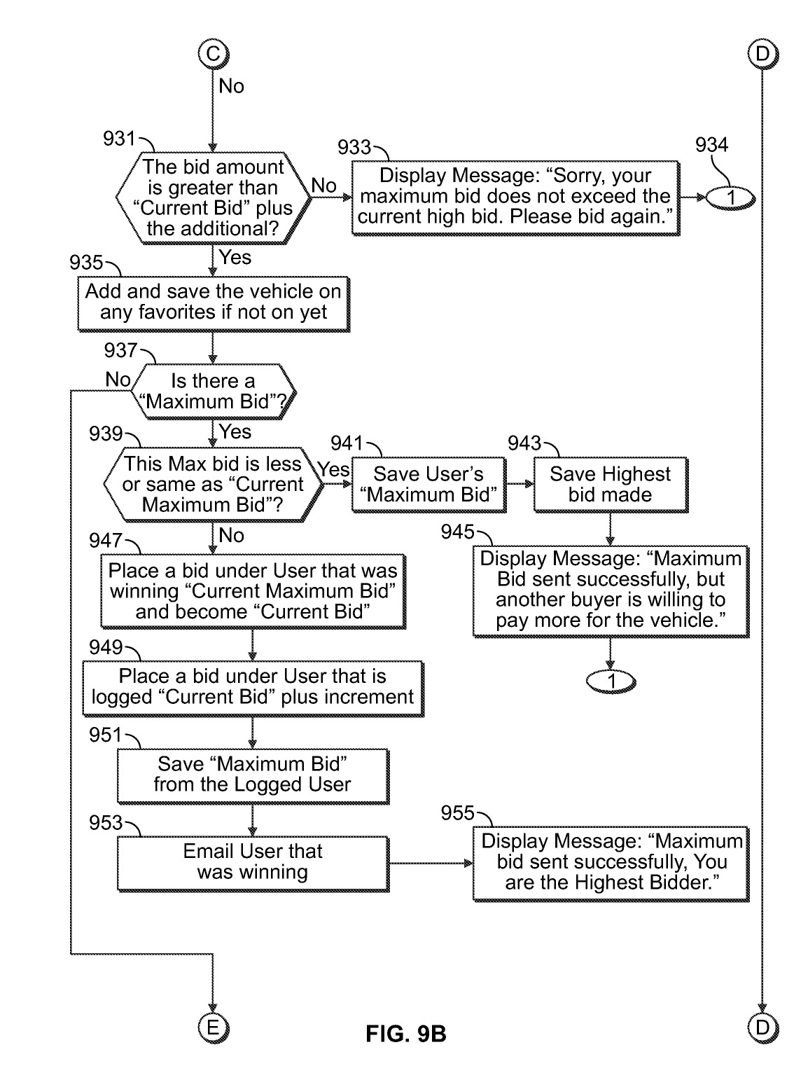

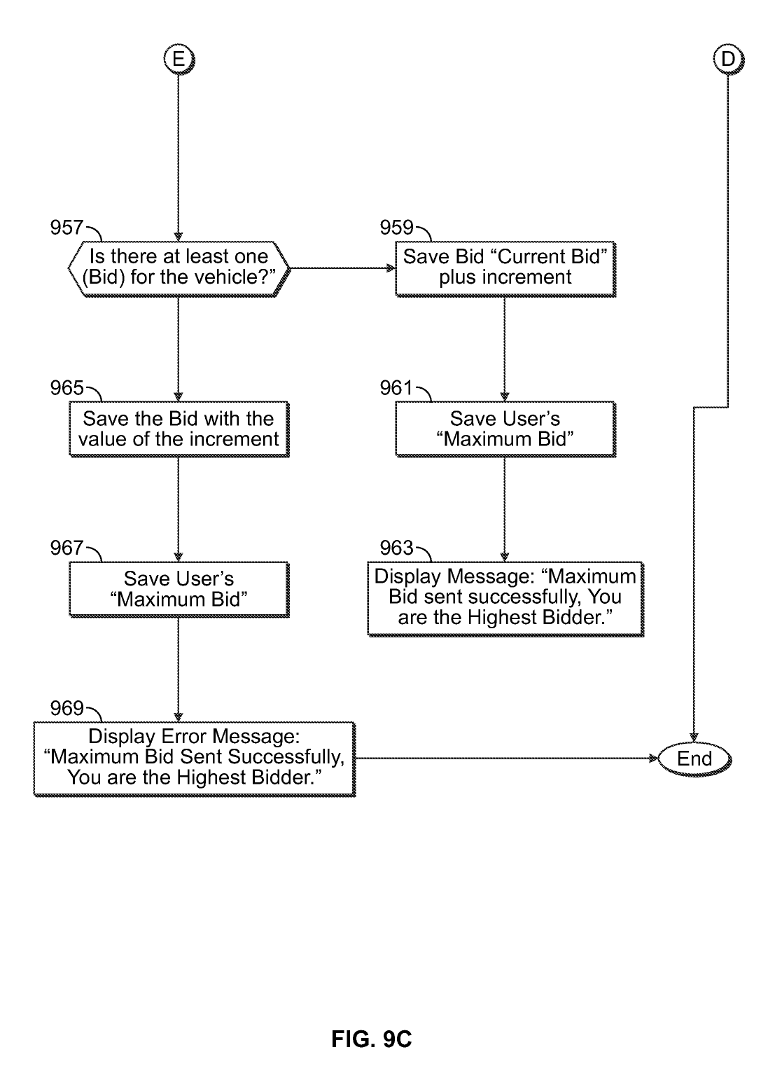

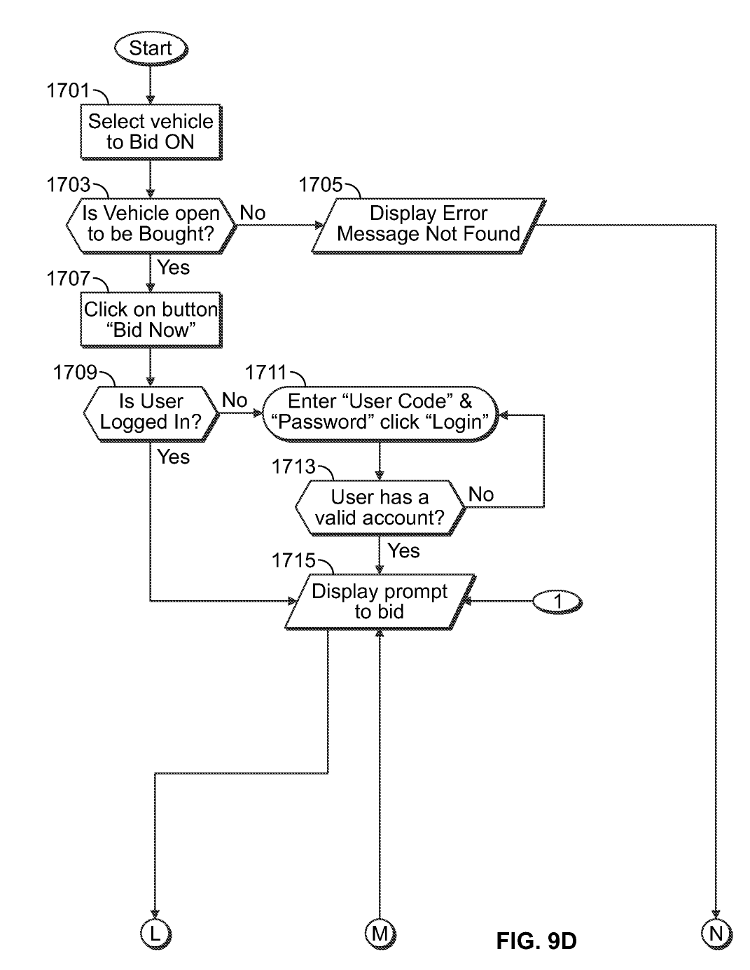

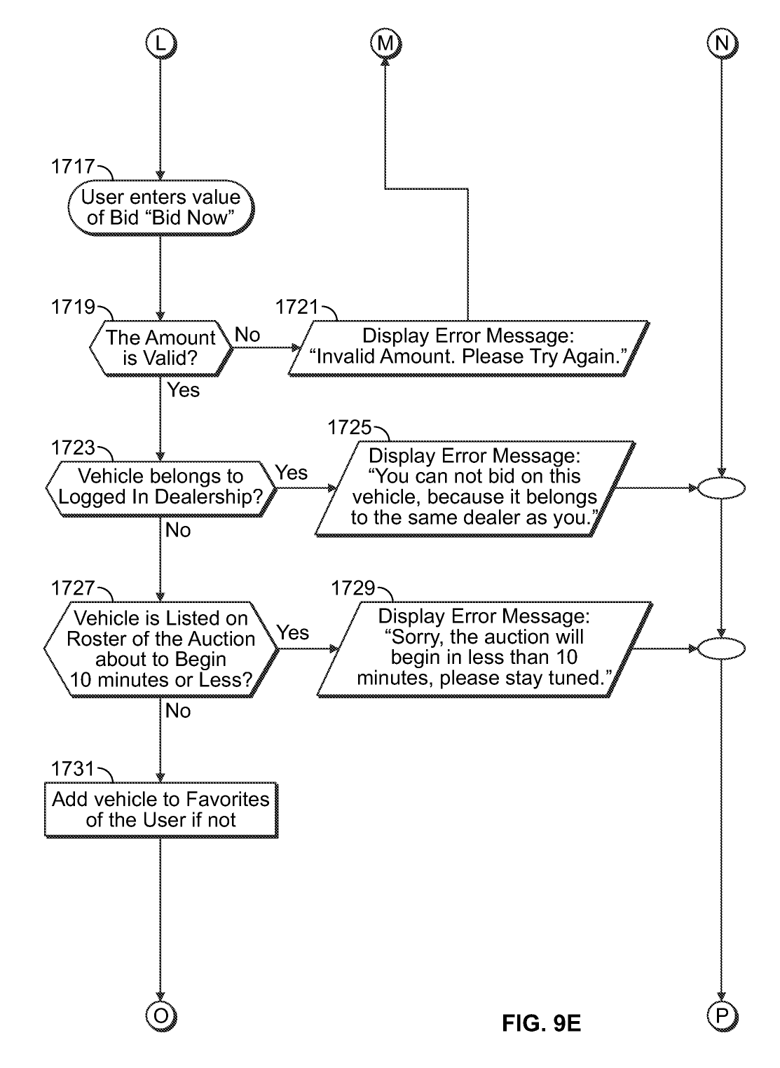

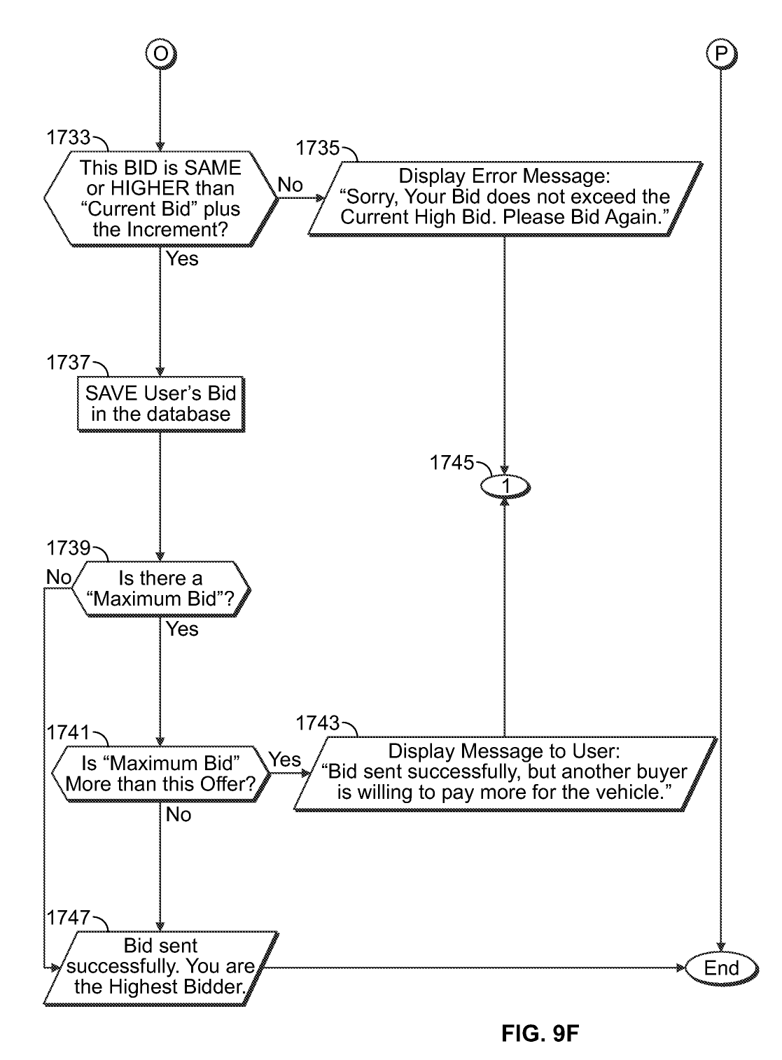

It is possible that a buyer wants to offer a price lower than the seller's “buy now” price for the seller's acceptance, or when the “buy now” price is not available. These offers from the buyers will be received and processed by the system database 101 in FIG. 1. The buyers can offer pre-bids to buy the vehicles at the pre-auction stage in two ways: they can either offer a regular pre-bid, or offer a maximum bid. FIGS. 9A, 9B, and 9C show the process of a buyer offering a maximum pre-bid and how the maximum bid is processed by the system. FIGS. 9D, 9E, and 9F show the process of a buyer offering a regular pre-bid and how the regular pre-bid is processed.

At step 901 in FIG. 9A, the buyer can select vehicle by typing key words in the search box on vehicles he or she is interested in. The buyer can also search by the listed selling dealers and view the inventory of each of the dealers. When the system checks and confirms that the selected vehicle is ready for purchase and the buyer is an eligible registered buyer at steps 903-913, the buyer can then proceed to make a maximum pre-bid at step 917. The entered maximum pre-bid must be greater than the current bid on the vehicle plus a predetermined incremental amount. If the entered maximum pre-bid is less than the required number, the maximum pre-bid will be held invalid at step 919, and an error message will be sent to the buyer that the maximum pre-bid value is invalid 921. The buyer will be redirected to step 915 to enter another amount and bid again.

In the maximum pre-bidding process, the system has to ensure that the vehicle is not owned by the bidding dealership. If the system determines the buyer offers a maximum pre-bid on his own vehicle at step 923, the buyer will receive an error notice at step 925. The buyer can then go back to select another vehicle to bid on. The system also has to ensure the maximum pre-bidding process is closed ten minutes before the online live auction starts. When the online live auction is to start in ten minutes or less, the system will give the buyer a notice at step 929 to remind the buyer to participate in the live auction in ten minutes.

The system will receive the buyer's maximum pre-bid to analyze if the maximum pre-bid is greater than the current bid saved in the system plus an incremental amount at step 931, shown in FIG. 9B. In one embodiment of the present invention, the pulsed incremental amount is set at twenty-five dollars. If the offered maximum pre-bid from the buyer is less than the current bid plus the incremental amount, the buyer will receive the message that the maximum pre-bid does not exceed the current high bid at step 933. The system will redirect the buyer to step 914 and 915 at step 934. The user will be instructed to insert a higher maximum pre-bid again.

Step 935 saves the vehicle to the buyer's favorite list if the vehicle is not in the buyer's favorite list yet. The system determines at step 937 whether there is any other buyer, who previously bid more than the current buyer's maximum bid. The system saves the current highest maximum pre-bid in the backend of the system and the amount of this saved maximum pre-bid is not revealed to any other biding buyers. If there is a saved maximum pre-bid in the system already, the current buyer's maximum pre-bid is compared with the system-saved maximum pre-bid at step 939. If the current buyer's maximum bid is less than or equal to the system-saved maximum pre-bid, the system will retain the system-saved maximum pre-bid as the highest pre-bid and inform the current offering buyer that this maximum pre-bid is sent and saved successfully but another buyer is willing to pay more for the vehicle” at step 945. The user will be directed to step 914 to make another maximum pre-bid.

However, if the current buyer's maximum pre-bid is greater than the system-saved maximum pre-bid, the system will place the bid under the current offering buyer at 947. The current buyer's maximum pre-bid is not revealed to the rest of the buyers. Instead, the system will post a bid on the current offering buyer's behalf, the placed amount is equal to the previous system-saved maximum pre-bid plus the predetermined increment as the current high bid at step 949. Therefore, other buyers will see the amount of the previous system-saved maximum pre-bid plus the increment, but not the actual maximum pre-bid entered by the current buyer. The current buyer's maximum pre-bid is saved as the system's maximum bid at step 951. The current buyer will get an email at 953 with a message that “maximum bid sent successfully. You are the highest bidder” at 955.

When there is no maximum pre-bid saved in the system previously, and if there is no bid for the vehicle at all 957, shown in FIG. 9C, the system will save the value of the increment as the current bid as long as it is higher than the predetermined increment at step 965. The current buyer's maximum pre-bid will become the current high maximum pre-bid at step 967. If there is at least one other buyer who offered a bid for the vehicle at step 957, instead of posting the actual offered maximum pre-bid, the system will post the current bid as previous current bid plus the increment at 959. The actual maximum pre-bid is therefore not disclosed to other buyers. The maximum pre-bid offered by the current buyer will be saved in the system at 961. The current buyer submitting the maximum bid will receive a message indicating he is the highest bidder 963.

Referring to FIGS. 9D, 9E, and 9F, the regular pre-bid process starts with the buyer selecting a vehicle to bid on at step 1701 in FIG. 9D. The system then determines whether the vehicle is open to be bought at step 1703 and sends an error message if the vehicle is not open to be bought at 1705. The buyer will select “bid now” to offer a regular pre-bid at step 1707. The system then checks if the user is logged in at step 1709. A user not logged in will need to enter a user code and password at step 1711, and the system verifies the entered information at step 1713.

The system will display the prompt to bid at 1715 and the user enters an amount for the regular pre-bid at 1717, shown in FIG. 9E. System checks the validity of the entered amount at step 1719. An invalid amount will be rejected and the system will display an error message at 1721. If the entered amount is valid, the system continues to check on the ownership of the vehicle at 1723. If the selected vehicle belongs to the buyer's dealership, the system will send an error message at step 1725.

Even if the vehicle does not belong to the buyer, the buyer cannot offer a regular pre-bid within a predetermined amount of time before the online live auction starts. The system determines the time remaining until the online live auction at 1727 and displays an error message if the auction will begin in less than the predetermine amount of time 1729. In the illustrated embodiment, the predetermined time is ten minutes. The system adds the selected vehicle to the buyer's favorite list at 1731 and compares the regular pre-bid the buyer entered with the current bid plus the increment at step 1733, shown in FIG. 9F. If the offered regular pre-bid is lower than current bid plus the increment, the system displays an error message to the buyer at step 1735. When the offered regular pre-bid is equal to or higher than current bid plus the increment, the system will save the buyer's regular pre-bid at 1737.

If the system determines there is a system-saved maximum pre-bid at 1739, this system-saved maximum pre-bid is compared with the offered regular pre-bid at 1741. If the system-saved maximum pre-bid is higher than the offered regular pre-bid, the system will send the current regular pre-bid buyer a message stating that “bid sent successfully, but another buyer is willing to pay more for the vehicle” at step 1743. The regular pre-bid offeror is then redirected to 1715, shown in FIG. 9D, from step 1745 to make another regular pre-bid again to win the vehicle. If the system-saved maximum pre-bid is less than the current regular pre-bid, the system will inform the current regular pre-bid offer that “you are the highest bidder” at step 1747. If the system determines there is no system-saved maximum pre-bid at 1739, the current regular pre-bidder will also win the present pre-bid, and will get the message at 1747.

The system collects these pre-bids until a predetermined time before the online auction of the vehicle starts. The pre-bidding results are not disclosed to the public. Only the highest bidder, the selling dealer and the system have information regarding the maximum pre-bid. The collected pre-bids are used in the online auction process detailed below.

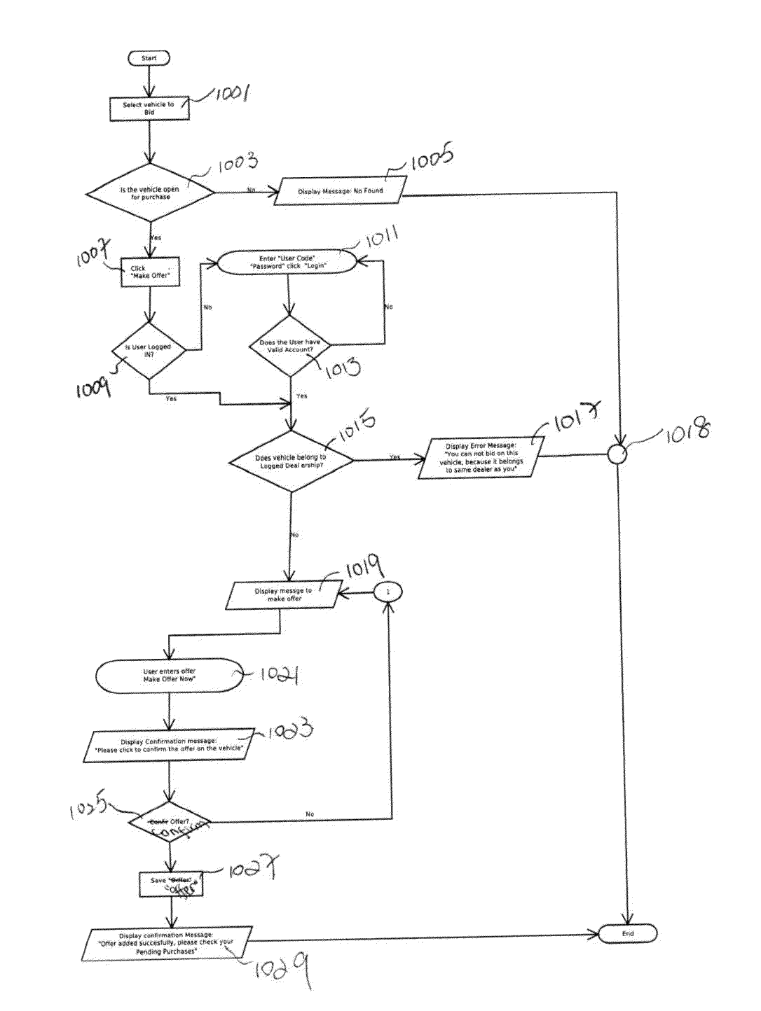

A buyer can offer the seller a price he desires to pay for a certain vehicle, and this offering process is illustrated in FIGS. 10A and 10B. Similar to the vehicle selecting process in step 901 from FIG. 9A, the buyer can select a vehicle to bid on in step 1001, shown in FIG. 10A. The system checks if the selected vehicle is open for purchase at step 1003 and sends an error message to the buyer that the vehicle is not found at step 1005 if the vehicle is not open for purchase yet. A buyer can offer to purchase a vehicle open for purchase by clicking “make offer” at step 1007. If the system detects the buyer is not logged in at step 1009, the system will require the buyer to enter user code and password to log in at step 1011. The validity of the user's account is verified at step 1013. The system checks if the offering buyer is logged in at step 1009 and whether the vehicle he/she offers belongs to the offering buyer at step 1015. An error message will be sent to the buyer at step 1017 if the vehicle belongs to the logged in dealership. A buyer cannot offer to buy their own vehicle, therefore if the vehicle belongs to the buyer, the system will redirect the buyer to either end the offering process or to select another vehicle to offer at step 1018.

The system will display a message to the buyer to make an offer at step 1019, shown in FIG. 10B. The buyer will enter the offer at step 1021 and confirm the offer at steps 1023-1025. The confirmed offer is then saved by the system and ready to be reviewed and selected by the seller at step 1027. The buyer will see a notice of “offer added successfully, please check your pending purchases” at step 1029.

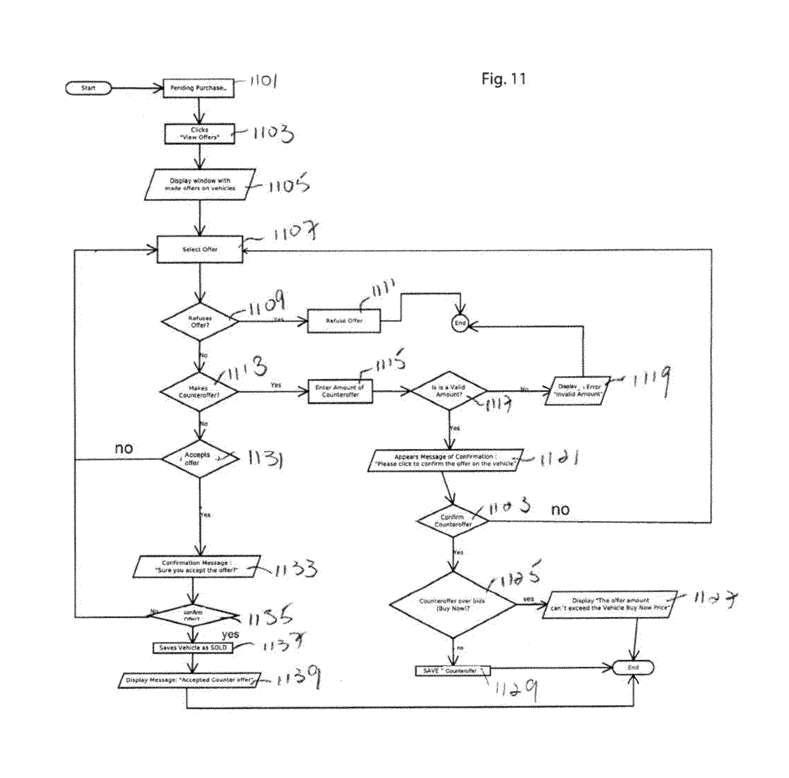

A selling dealer can review and select the submitted offers from buyers via the process illustrated in FIGS. 11A and 11B. The pending purchasing offers saved in the system are ready to be viewed at step 1101, shown in FIG. 11A. The selling dealer can view these offers at 1103 and 1105, and select the offer to act on at 1107. The selling dealer can refuse the offer at step 1109, make a counteroffer at step 1113, or accept the offer at step 1131. If the selling dealer refuses the offer at step 1109, the system refuses the offer at step 1111 on the selling dealer's behalf, and terminates the negotiation. If the selling dealer wants to counter offer the offering buyer at step 1113, the dealer can enter the amount of the counter offer at step 1115. The system will then check the validity of the offer at step 1117, and have the selling dealer confirm the offer at steps 1121 and 1123, shown in FIG. 11B. If the system determines the amount of counteroffer is invalid, the system will display an error message at 1119, shown in FIG. 11A, to the selling dealer that the amount entered was invalid. Referring to FIG. 11B, the counteroffer amount cannot exceed the “buy now” amount in a transaction. If the system detects the amount of counteroffer exceeds the “buy now” amount at step 1125, the system will display an error message to inform the seller at step 1127. The system will save the counteroffer amount if the counteroffer does not exceed the “buy now” price.

If the selling dealer chooses to accept the offer at step 1131, the system will confirm the acceptance with the seller at steps 1133 and 1135. After the confirmation is received, the system will save the vehicle as “sold” at 1137 and send the acceptance status to the seller and buyer at step 1139.

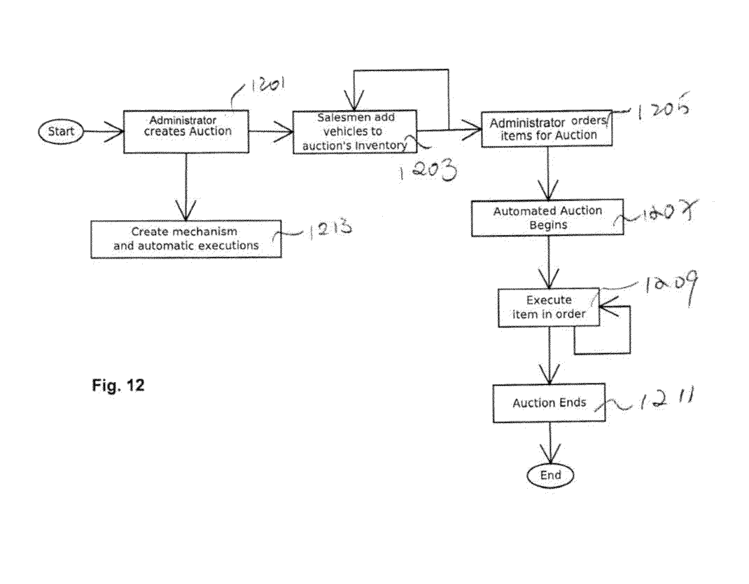

The vehicles remaining in the auction list when the auction starts will be auctioned under the administrator's control 119 in FIG. 1. The administrator creates and executes the order and results of the auction. Referring to FIG. 12 a flow diagram of the administrative control of the auction process is illustrated. The administrator creates an upcoming auction session at step 1201. The salesmen of the system will then add the vehicles to be auctioned into the auction session inventory at step 1203. After the information of the vehicles to be auctioned is fully loaded into the system, the administrator will place the vehicles in order for the auction at step 1205. The ranked vehicles are linked in a queue before the auction starts and will be auctioned in that order when the auction begins. The system starts the automated auction at step 1207 and the vehicles are auctioned in order, one vehicle at a time in step 1209. The vehicle auction will repeat until all the vehicles in one auction session are sold. The auction can also be arranged automatically by the system without the manual ranking and ordering by the administrator in one embodiment illustrated in step 1213.

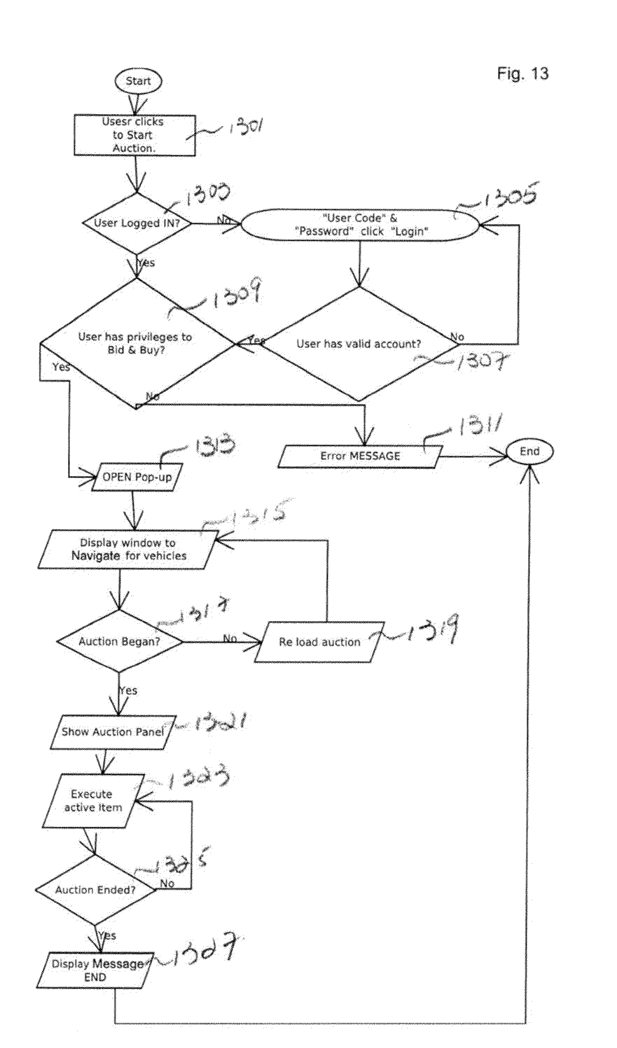

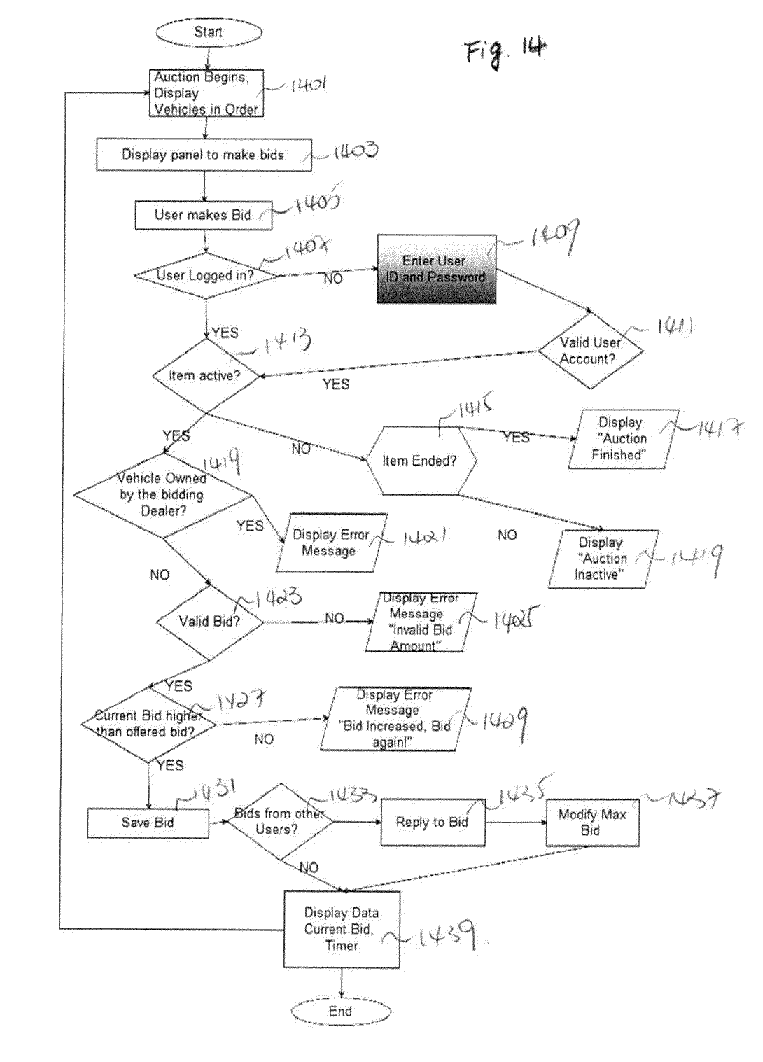

The general auction process is illustrated in FIG. 13. A buyer clicks to enter into an auction session at step 1301. The system then checks the identity of the buyer, including the login status of the buyer and the buyer's privilege to bid and buy in steps 1303-1311. When the system confirms that the buyer is registered and has the privilege to bid, the system will present the buyer with a pop-up window at step 1313 to display and navigate for vehicles at step 1315. The buyer cannot enter into an auction session unless the session has already begun at step 1317. Step 1319 will redirect the buyers to the navigation window until the auction session has begun. The buyer will be able to see the auction panel and participate in the auction execution in steps 1321-1325.

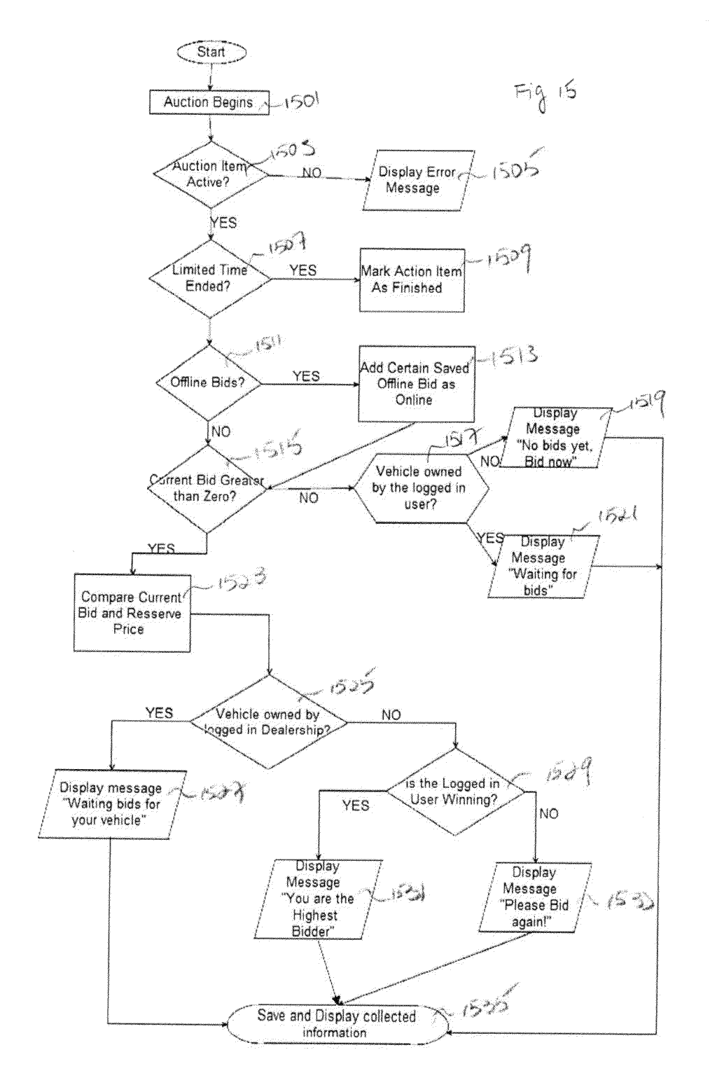

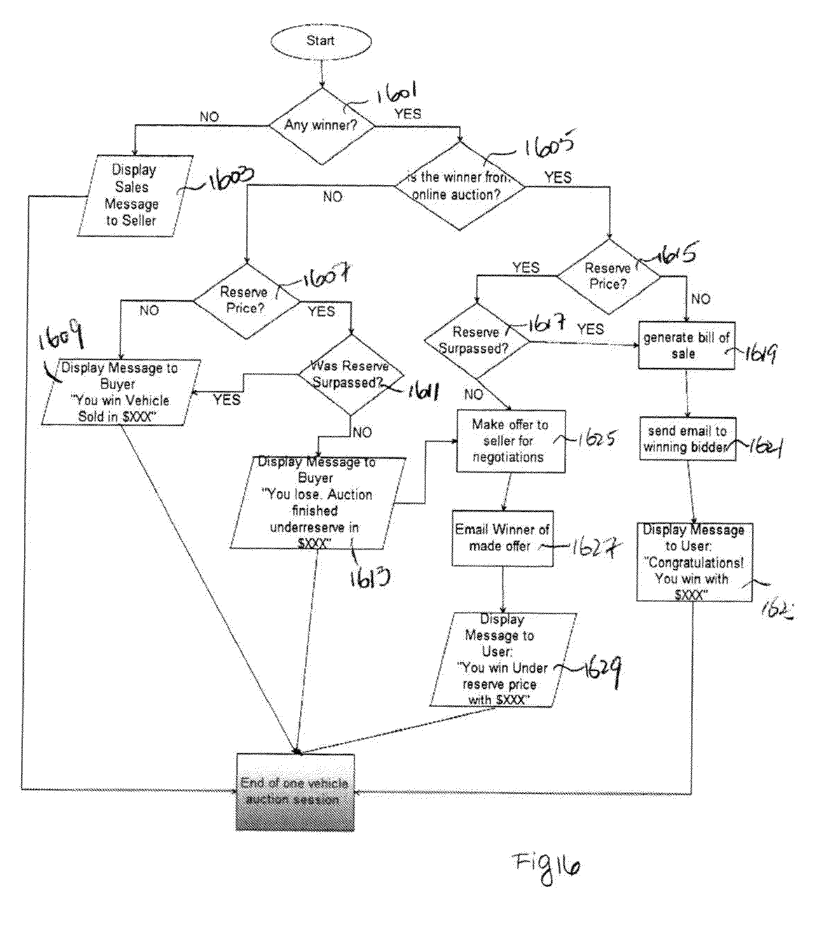

The detailed auction process is illustrated in FIGS. 14-16. Once the online live auction starts, the system will accept bids from real online buyer's bids and start to divulge the pre-bids collected in the pre-bidding process illustrated in FIGS. 9 and 9A. The online live bids and offline pre-bids already collected by the system will be synchronized by the system and posted to the public one by one until the high bidder is established. FIG. 14 shows the process of entering an online live bid, and FIG. 15 shows the process of divulging the pre-bids collected through the pre-bidding and the processing of pre-bids and online bids. FIG. 16 shows the determination of the winner of the auction.

Referring to FIG. 14, the illustrated process starts at the beginning of the auction. At step 1401, the system displays the vehicles to be auctioned in a predetermined order. The buyer can bid on a vehicle when the bidding panel is shown in the bidding page at step 1403. The user then enters a bid at step 1405. The system will check the buyer's log in status and validity of the buyer's account in steps 1407-1411. If the vehicle the buyer bids on is determined not active by the system at step 1413, the system will determine at step 1415 whether it is because the bidding has ended for this item. If the bidding session has already ended for this particular vehicle, the system will display an “auction finished” notice to the buyer at step 1417. If the bidding session for this vehicle has not ended yet, the system will display an “auction inactive” notice to the buyer at step 1419.

If the buyer bids on an active vehicle, the system checks whether the vehicle is already owned by the bidding buyer. If the bidding buyer owns the vehicle they bid on, the system will return an error notice 1421 “you cannot make offers because this vehicle is of your same dealership.” If the bidding buyer passes the ownership check, the system continues to check on the validity of the offered amount at step 1423. An invalid amount may be less than the current bid plus the predetermined increment. When the bidding price is invalid, the system will display an error message 1425 to the bidder to inform the bidder the amount entered is invalid.

When the buyer offers a valid bid, the system will check if there is any other currently saved bid that is higher than the offered bid at step 1427. The current saved bids are the saved bids from the pre-bidding process. If there is another saved bid higher than the offered bid, the system will display an error message to the bidding buyer that “Bid increased, Bid again” at step 1429. The system will automatically bid on behalf of the higher system-saved pre-bidder to increase the current bid. The new current bid will be increased to the current buyer's bid plus the increment. If the bidding buyer's bid is not exceeded by another saved system-saved maximum pre-bid, the bidding buyer's bid will be saved at step 1431.

When the system receives other bids from various bidders at step 1433, the system will conduct the same process to check the bidder and the bid, and the result will be the reply to the bidder at step 1435. If the maximum bid is changed after another bidder submits a bid, the system maximum bid will be changed and saved at step 1437. The system will send the winning bidder a message of the current bid and “you are the highest bidder.” The system will also post the current winning bid during the online live auction process for the auction participants 1439. Whenever the system receives a high bid, the system will reset the auction timer to a random count down time. Because of the uncertainty of remaining time in an auction session, the participating bidders of the present system are encouraged to bid on the vehicles aggressively. Once the randomly set timer runs out of time, the live auction session for a particular vehicle is also ended.

FIG. 15 is an embodiment of the system divulging the pre-bids collected through the pre-bidding and the processing of pre-bids and online bids. The system starts the auction at step 1501 and checks if the vehicle being auctioned is active at step 1503 and is within the limited time to bid at step 1507. The system marks the item finished at step 1509 if the limited time has ended. If there were buyers offering on the vehicle being auctioned during the pre-bid process, those pre-bidding offers will be divulged one by one once the online auction begins at step 1513. Any real-time online bid received by the system during the online auction will be compared with the saved pre-bids by the system, a process illustrated in steps 1427-1439 in FIG. 14.

The system checks offline bids at step 1511 and posts offline bids one by one as entered from the lowest price to higher ones in a random time. When there are no offline bids, the system determines whether the current bid is greater than zero at step 1515. In the circumstance that the current bid is zero, the system determines whether the vehicle is owned by the logged in user at step 1517. If the system determines that the logged in user is checking on their own vehicle, the system will display a message at step 1521 to the user that the vehicle is waiting for bids. If the system determines that the logged in buyer is not the owner of the vehicle, the system displays a message to the buyer at step 1519 that there are no bids yet, and asks the buyer to bid now.

If the system determines that the current bid for the vehicle is greater than zero at step 1515, the system then compares the current bid with the reserved price of the vehicle at step 1523. If the vehicle is owned by the logged in dealership 1525, the system will display a message to the dealer that the vehicle is currently waiting for bids 1527. If the logged in user is not the owner of the vehicle, and the user is the winning bidder 1529, the system will display a message 1531 informing user that “You are the highest bidder.” However, if the logged in user is not winning, the system displays the message to encourage the bidder to bid again 1533.

All of the posted bids from the pre-bidding session and the bids from online users during the online bidding session are collected and saved by the system at 1535 and automatically synchronized during the online auction process. The online auction automatically picks up the online auction bids and processes the pre-bidding session bids saved in the database. The processing continues until the online auction time runs out and a high bid is established.

FIG. 16 shows the process of determining the winner of the auction after the bidding time ends. If there is no winning bidder 1601, the system sends the selling dealership, at step 1603, a message that tells the dealer that no one has bid on the vehicle and the auction is finished. If there was a winning bid received, the system determines at step 1605 whether the winner is from the online auction process. If the winner is not from online process, this means that an offline (pre-bidding session) buyer wins the vehicle. The system will check if the vehicle has a reserved price at step 1607. If there is no reserved price for the vehicle, the system will tell the buyer “You win and vehicle is sold in XXX” 1609. If the vehicle was agreed to be sold above a reserved price, the system determines whether the reserve is surpassed at step 1611. If the reserve is surpassed, the system will send buyer the same message as in step 1609. If the reserve is not surpassed, the buyer cannot win the vehicle even if their bid was the highest bid. The system will send buyer a message 1613 informing the buyer that “you are the highest bidder but reserve price is $XXXX.” The vehicle will be displayed under buyer's dashboard under pending purchases under negotiations at the buyer's option. If the buyer decides to make an offer, he or she will be directed to offer options at 1625 detailed hereinafter. If the buyer decides not to negotiate the purchase, this auction session will be terminated. If no action is taken within 24 hours from the end of the live auction, the auction session will be terminated.

If the winning bidder is from the online auction process, the system will also determine if the online bid from the buyer passes the reserve price. The system checks if there is a reserve price for the vehicle at step 1615. If there is no reserved price, or the reserved price is surpassed 1617, the system will generate a bill of sale at step 1619 and inform the buyer at 1621 that he/she wins the auction 1623. If the reserved price is not surpassed, the system will allow the buyer to offer the seller a higher price for negotiation at step 1625. If the seller accepts the buyer's offer at step 1627, the vehicle will be sold to the buyer at the offered price at 1629.

While one particular embodiment of an electronic online motor vehicle management and auction system of the present invention has been shown and described, it will be apparent to those skilled in the art that changes and modifications may be made without departing from the true spirit and scope of the present invention. It is the intent of the appended claims to cover all such changes and modifications as fall within the true spirit and scope of the invention.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

1. A method for standardized online vehicle management and auction accomplished via a computer system comprising hardware, software, and a mobile electronic device, comprising the steps of:
a. inspecting a selling dealer's vehicle onsite by a qualified technician with the mobile electronic device comprising a database, a central processing unit, a display unit, and pre-loaded standardized inspecting procedures for said technician to follow during said inspection;
b. entering the inspection related information and results into the database of the mobile electronic device;
c. uploading said inspection related information and results directly from said mobile device to a database of a remote computer system;
d. the remote computer system generating a general information report for a buyer, said general information report including said inspection related information and results, and a financial information portion of the general information report;
e. the remote computer system providing a pre-bid session with a plurality of purchasing options related to the vehicles;
f. collecting at least one pre-bid from at least one potential buyer;
g. providing an online live auction session to collect at least one online live bid from at least one online buyer;
h. posting to the at least one online buyer said at least one pre-bid collected during said online live auction session, said posting following a first predetermined process;
i. determining one final awarded bid based on a second predetermined process.

2. The method of claim 1, wherein said pre-loaded standardized inspecting procedures includes at least one of:
a. receiving and decoding the vehicle identification number;
b. receiving basic data information of the vehicle that includes at least one of a vehicle history, factory warranty, a vehicle category, a dealer stock number assigned to the vehicle, a vehicle mileage, a vehicle title status, and a year the vehicle was built;
c. receiving optional equipment information of the vehicle;
d. receiving a condition report of the vehicle that includes information regarding at least one of the interior and exterior of the vehicle, a mechanical and test drive statement, glass condition, and removable condition and determining an evaluation grade for the inspected vehicle by said qualified technician;
e. receiving the tire and wheel information associated with the vehicle that includes at least one of a brand, a size, a thread depth, and status information; and
f. receiving multimedia information of the vehicle that includes at least one of editable still images and motion videos.

3. The method of claim 2, wherein said editable still images can be edited through tagging specific areas on the image to associate said specific areas with a statement input by said technician.

4. The method of claim 2, wherein said condition report is input into said mobile electronic device through selecting at least one appropriate keyword from the keyword list provided by the system, said condition report manually editable by the qualified technician.

5. The method of claim 1, wherein said financial information portion of the general information report includes a “buy now” offer from the selling dealer, a reserved price, and a preference on how the vehicle is to be auctioned from the selling dealer.

6. The method of claim 1, wherein said plurality of purchasing options related to the vehicle correspond with said financial information portion of the general information report.

7. The method of claim 5, wherein said at least one potential buyer can accept the “buy now” offer from the selling dealer to finalize the purchase of the vehicle.

8. The method of claim 1, wherein said pre-bid session includes a maximum pre-bidding session and a regular pre-bidding session.

9. The method of claim 8, wherein said maximum pre-bidding session includes receiving a maximum pre-bid from said potential buyer, verifying said maximum pre-bid, comparing said maximum pre-bid with said collected pre-bids to determine a first system current pre-bid price and a second system saved maximum pre-bid price.

10. The method of claim 9, wherein said regular pre-bidding session includes taking a regular pre-bid from said at least one potential buyer, verifying said regular pre-bid, comparing said regular pre-bid with said collected pre-bids to determine a current higher pre-bid.

11. The method of claim 1, wherein said first predetermined process includes posting the collected off-line pre-bids one by one from the lowest price to the highest price in a random time, comparing said collected online live bids with collected off-line pre-bids, and posting a current bid when a high bid is established.

12. The method of claim 1, wherein said second predetermined process includes comparing a high bid received from said pre-bid session and said online live auction session with a reserved price provided by the selling dealer and awarding the high bid when the high bid exceeds the reserved price.

13. A system for standardized online vehicle management and auction, comprising:
a. an electronic computer system including hardware, software, and a mobile electronic device for entering information about a vehicle in at least one of a database of the mobile electronic device and a database of the system;
b. said computer system including a server for receiving and storing information over the Internet from the mobile electronic device; and
c. a software application associated with the mobile electronic device and the server for
i. inspecting a selling dealer's vehicle onsite by a qualified technician with the mobile electronic device comprising a database, a central processing unit, a display unit, and pre-loaded standardized inspecting procedures for said technician to follow during said inspection;
ii. entering the inspection related information and results into the database of the mobile electronic device;
iii. uploading said inspection related information and results directly from said mobile device to a database of a remote computer system;
iv. the remote computer system generating a general information report for a buyer, said general information report including said inspection related information and results, and a financial information portion of the general information report;
v. the remote computer system providing a pre-bid session with a plurality of purchasing options related to the vehicles;
vi. collecting at least one pre-bid from at least one potential buyer;
vii. providing an online live auction session to collect at least one online live bid from at least one online buyer;
viii. posting to the at least one online buyer said at least one pre-bid collected during said online live auction session, said posting following a first predetermined process; and
ix. determining one final awarded bid based on a second predetermined process.

14. The system of claim 13, wherein said pre-loaded standardized inspecting procedures includes at least one of:
a. receiving and decoding the vehicle identification number;
b. receiving basic data information of the vehicle that includes at least one of a vehicle history, factory warranty, a vehicle category, a dealer stock number assigned to the vehicle, a vehicle mileage, a vehicle title status, and a year the vehicle was built;
c. receiving optional equipment information of the vehicle;
d. receiving a condition report of the vehicle that includes information regarding at least one of the interior and exterior of the vehicle, a mechanical and test drive statement, glass condition, and removable condition and determining an evaluation grade for the inspected vehicle by said qualified technician;
e. receiving the tire and wheel information associated with the vehicle that includes at least one of a brand, a size, a thread depth, and status information; and
f. receiving multimedia information of the vehicle that includes at least one of editable still images and motion videos.

15. The method of claim 14, wherein said editable still images can be edited through tagging specific areas on the image to associate said specific areas with a statement input by said technician.

16. The method of claim 14, wherein said condition report is input into said mobile electronic device through selecting at least one appropriate keyword from the keyword list provided by the system, said condition report manually editable by the qualified technician.

17. The method of claim 13, wherein said financial information portion of the general information report includes a “buy now” offer from the selling dealer, a reserved price, and a preference on how the vehicle is to be auctioned from the selling dealer.

18. The method of claim 13, wherein said plurality of purchasing options related to the vehicle correspond with said financial information portion of the general information report.

19. The method of claim 17, wherein said at least one potential buyer can accept the “buy now” offer from the selling dealer to finalize the purchase of the vehicle.

20. The method of claim 13, wherein said pre-bid session includes a maximum pre-bidding session and a regular pre-bidding session.

21. The method of claim 20, wherein said maximum pre-bidding session includes receiving a maximum pre-bid from said potential buyer, verifying said maximum pre-bid, comparing said maximum pre-bid with said collected pre-bids to determine a first system current pre-bid price and a second system saved maximum pre-bid price.

22. The method of claim 21, wherein said regular pre-bidding session includes taking a regular pre-bid from said at least one potential buyer, verifying said regular pre-bid, comparing said regular pre-bid with said collected pre-bids to determine a current higher pre-bid.

23. The method of claim 13, wherein said first predetermined process includes posting the collected off-line pre-bids one by one from the lowest price to the highest price in a random time, comparing said collected online live bids with collected off-line pre-bids, and posting a current bid when a high bid is established.

24. The method of claim 13, wherein said second predetermined process includes comparing a high bid received from said pre-bid session and said online live auction session with a reserved price provided by the selling dealer and awarding the high bid when the high bid exceeds the reserved price.
